(19) United States
(12) Patent Application Publication
(10) Pub. No.: US 2007/0159777 A1
(43) Pub. Date: Jul. 12, 2007

(54) Chassis assembly and display apparatus having the same

(76) Inventor: Dong-Hyok Shin, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/636,807

(22) Filed: Dec. 11, 2006

(30) Foreign Application Priority Data
Dec. 22, 2005 (KR) 10-2005-0127792

(51) Int. Cl. G06F 1/16

(52) U.S. Cl. 361/681

(57) ABSTRACT

A chassis assembly and a display apparatus that uses the chassis assembly are disclosed. In one embodiment, the chassis assembly includes a chassis that supports a display panel from a rear of the display panel and has a plurality of functional holes, and a vibration preventive member that is inserted into at least one of the functional hole and are disposed such that a front end of the vibration preventive member presses the display panel. According to at least one embodiment, the generation of vibration and noise from a display panel can be prevented by selectively pressing the display panel where the vibration is generated using vibration preventive members.

### CROSS-REFERENCE TO RELATED PATENT APPLICATION

This application claims the benefit of Korean Patent Application No. 10-2005-0127792, filed on Dec. 22, 2005, in the Korean Intellectual Property Office, the disclosure of which is incorporated herein in its entirety by reference.

### BACKGROUND OF THE INVENTION

1. Field of the Invention

The present invention relates to a chassis assembly and a display apparatus having the chassis assembly, and more particularly, to a chassis assembly having a structure that can readily reduce vibration and noise generated from a plasma display panel and a plasma display apparatus having the chassis assembly.

2. Description of the Related Technology

FIG. 1 is a perspective view of a conventional plasma display apparatus having a plasma display panel. Referring to FIG. 1, the display apparatus includes a plasma display panel 10 and a chassis 30 that supports the plasma display panel 10 from behind. Although it is not depicted, a rear surface of the chassis 30 supports a predetermined number of driving circuit boards consisting of circuits for driving the plasma display panel 10.

The plasma display panel 10 and the chassis 30 are coupled to each other using an adhesive member 15 such as a double-sided tape. Also, a heat dissipation member 16 that transmits heat generated from the plasma display panel 10 to the chassis 30 is interposed between the plasma display panel 10 and the chassis 30.

In the case of a plasma display panel constituting a display apparatus, a discharge gas filled in the plasma display panel generates plasma discharge as a voltage is applied, and visible light is emitted from a phosphor layer by ultraviolet rays generated by the plasma discharge. During the plasma discharge, noise and vibrations are generated.

Also, bosses for supporting the driving circuit boards are mounted on the chassis 30. However, the sizes of the driving circuit boards are not uniform and the locations of the driving circuit boards vary according to the specification of the display apparatus. Accordingly, in the prior art, after forming a number of bosses, the driving circuit boards are supported on the bosses as required according to the specification. For this reason, many bosses must be formed on the chassis, thereby complicating the manufacturing process and increasing manufacturing costs.

### SUMMARY OF CERTAIN INVENTIVE ASPECTS

One aspect of the present invention provides a chassis assembly having a structure which can reduce vibration and noise generated from a display panel and a plasma display apparatus having the chassis.

Another aspect of the present invention provides a chassis assembly comprising: a chassis that supports a display panel from a rear of the display panel and has a plurality of functional holes and a vibration preventive member that is inserted into at least one of the functional holes and is disposed such that a front end of the vibration preventive member presses the display panel.

The vibration preventive member may be formed of a plastic material or a rubber material.

A screw tap may be formed in the functional holes, and the vibration preventive member may be screw coupled to the functional hole.

The chassis may further comprise a circuit board seating member that supports at least one circuit board electrically connected to the display panel by being inserted into at least one of the functional holes.

The vibration preventive member may comprise: a panel supporting unit protruding from a front of the chassis to press the display panel a coupling unit which is coupled to the chassis and a circuit board supporting unit that protrudes from a back of the chassis and is coupled to the circuit board electrically connected to the display panel.

The chassis assembly may further comprise a heat dissipation thin plate which is formed of a material having high thermal conductivity and is inserted into at least one of the functional holes.

Still another aspect of the present invention provides a display apparatus comprising: i) a display panel on which images are displayed, ii) a chassis that supports the display panel from a rear of the display panel and has a plurality of functional holes and iii) a vibration preventive member that is inserted into at least one of the functional holes and is disposed such that a front end of the vibration preventive member presses the display panel.

The display panel may display images using plasma discharges.

### BRIEF DESCRIPTION OF THE DRAWINGS

Embodiments of the present invention will be described with reference to the attached drawings.

FIG. 1 is a perspective view of a conventional plasma display apparatus.

FIG. 2 is a perspective view of a chassis assembly and a plasma display apparatus having the chassis assembly according to an embodiment of the present invention.

FIG. 3 is a cutaway exploded perspective view of a plasma display panel illustrated in FIG. 2, according to an embodiment of the present invention.

FIG. 4 is an exploded perspective view of the chassis assembly of FIG. 2, according to an embodiment of the present invention.

FIG. 5 is a cross-sectional view taken along a line V-V of FIG. 2, according to an embodiment of the present invention.

FIG. 6 is a cross-sectional view taken along a line VI-VI of FIG. 2, according to another embodiment of the present invention.

FIG. 7 is a cross-sectional view taken along a line VII-VII of FIG. 2, according to another embodiment of the present invention.

FIG. 8 is a cross-sectional view taken along a line VIII-VIII of FIG. 2, according to another embodiment of the present invention.

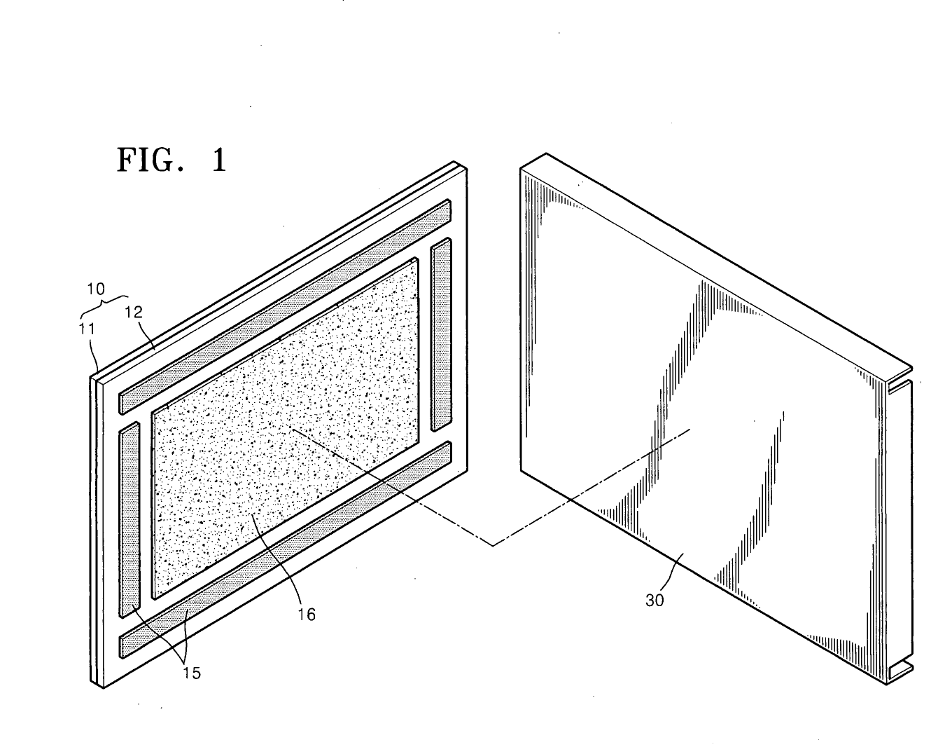

### DETAILED DESCRIPTION OF CERTAIN INVENTIVE EMBODIMENTS

Embodiments of the present invention will now be described more fully with reference to the accompanying drawings in which exemplary embodiments of the invention are shown. In one embodiment, a plasma display apparatus that displays images using a plasma discharge is described as a display apparatus. Another embodiment can be applied to any display panel that is supported by a chassis.

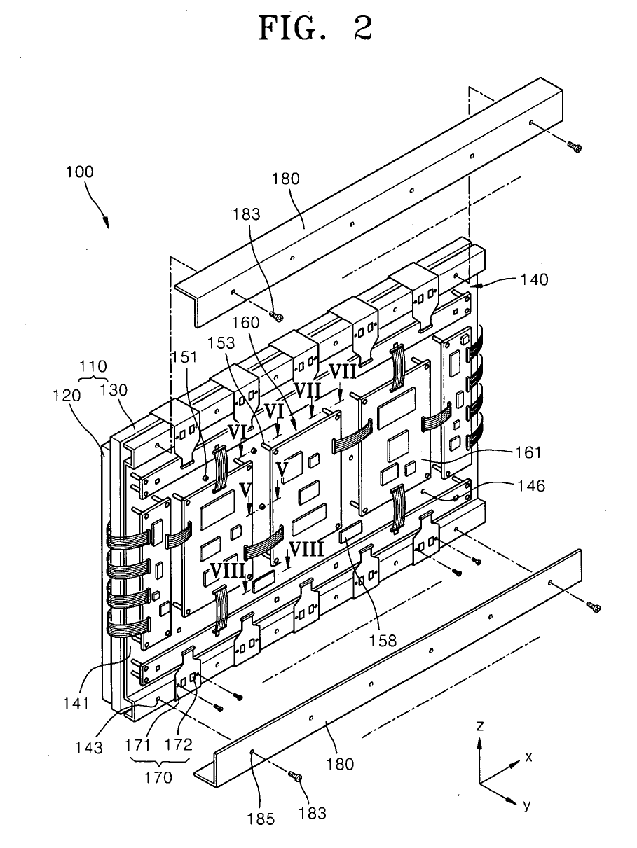

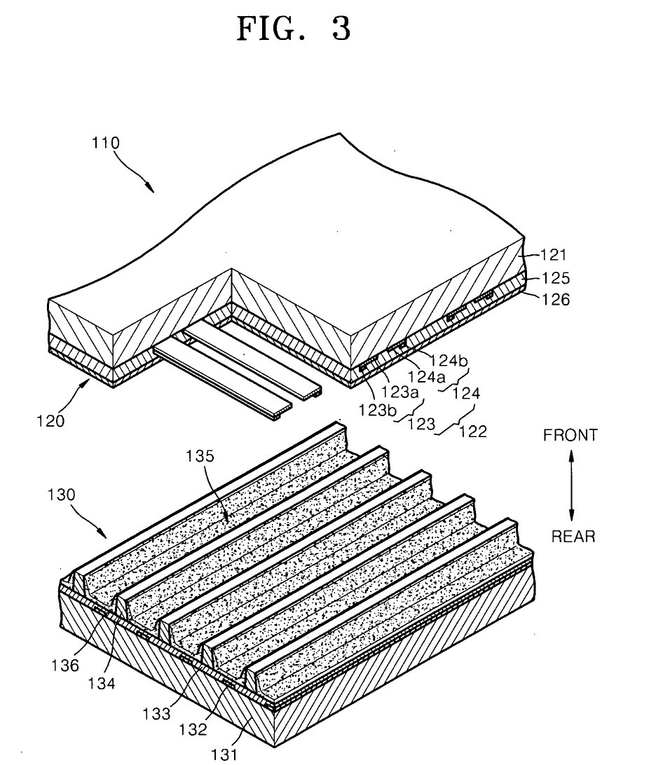

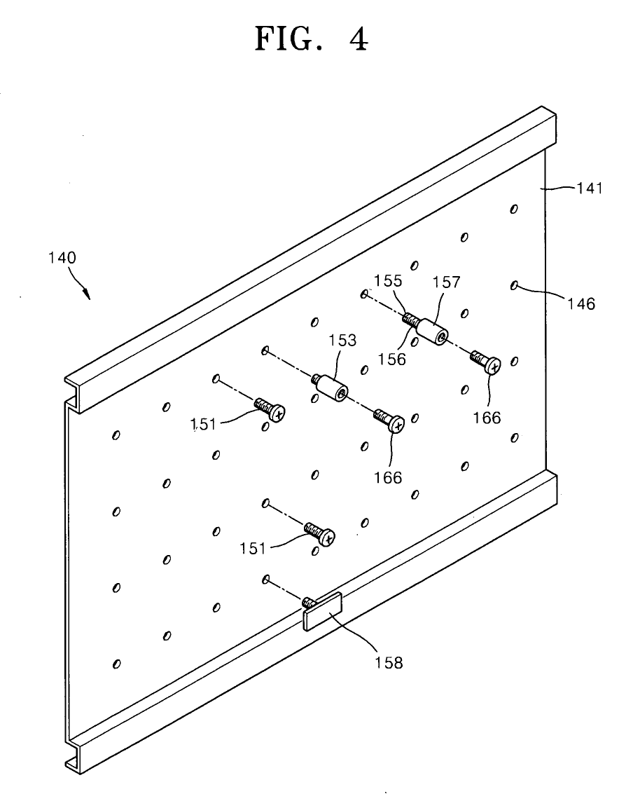

FIG. 2 is a perspective view of a chassis assembly 140 and a plasma display apparatus having the chassis assembly 140 according to an embodiment of the present invention. FIG. 3 is a cutaway exploded perspective view of a plasma display panel illustrated in FIG. 2, according to an embodiment of the present invention, and FIG. 4 is an exploded perspective view of the chassis assembly 140 of FIG. 2, according to an embodiment of the present invention.

Referring to FIG. 2, the chassis assembly 140 includes a chassis 141 and a vibration preventive member 151. The chassis 141 supports a display panel 110 such as a plasma display panel from a rear side of the display panel 110 (y direction in FIG. 2). Also, the chassis 141 can support at least one circuit board 161 that drives the display panel 110 from a front side of the circuit board 161. In one embodiment, a plurality of functional holes 146 (or through-hole) are formed in the chassis 141. In one embodiment, the functional holes 146 can be arranged across the entire surface of the chassis 141, for example, in parallel to upper, lower, left, and right sides of the chassis 141. In another embodiment, the functional holes 146 can be concentrated in a region of the display panel 110 where noise is frequently generated.

In one embodiment, the vibration preventive member 151 is inserted into at least one of the functional holes 146, and a front end of the vibration preventive member 151 presses the display panel 110.

The chassis assembly 140 having the chassis 141 and the vibration preventive member 151 will be described in detail later.

In one embodiment, as shown in FIG. 3, the display panel 110 is an AC type plasma display panel having a surface discharge three-electrode structure that can be applied to the plasma display apparatus of FIG. 2. In another embodiment, other display apparatus can be also possible as long as a display panel thereof is supported by the chassis 141. For convenience, it is assumed that the display panel 110 is a plasma display panel, and identical reference numerals used to the display panel and the plasma display panel, but the present invention is not limited thereto.

Referring to FIG. 3, the plasma display panel 110 includes a front panel 120, a rear panel 130 that is coupled to the front panel 120 and faces the front panel 120, a plurality of barrier ribs 134, sustain electrode pairs 122, address electrodes 132, and phosphor layers 136.

More specifically, the front panel 120 includes a front substrate 121 disposed in a front side of the front panel 120 and the sustain electrode pairs 122 formed on a rear surface of the front substrate 121. Each of the sustain electrode pairs includes an X electrode 123 and a Y electrode 124 in each discharge cell. The X electrode 123 and the Y electrode 124 that constitute the sustain electrode pairs 122 respectively serve as a common electrode and a scan electrode, and are separated from each other by a discharge gap. The X electrode 123 can include an X transparent electrode 123a and an X bus electrode 123b formed to be connected to the X transparent electrode 123a. The Y electrode 124 can include a Y transparent electrode 124a and a Y bus electrode 124b formed to be connected to the Y bus electrode 124a.

The rear panel 130 includes a rear substrate 131 that is separated from a rear of the front substrate 121 and form discharge spaces 135 between the front substrate 121 and the address electrodes 132 which are formed on a front surface of the rear substrate 131 and cross the sustain electrode pairs 122. In this case, the phosphor layers 136 are formed in each of the discharge spaces 135. The sustain electrode pairs 122 can be covered by a front dielectric layer 125, a protective film 126 can be formed on a rear surface of the front dielectric layer 125. Also, the address electrodes 132 can be covered by a rear dielectric layer 133. In this case, the barrier ribs 134 can be formed on the rear dielectric layer 133. The display panel 110 depicted in FIG. 3 is merely an example of a plasma display panel, and a display panel having other configuration is also possible.

Referring to FIG. 2 again, the chassis 141 is disposed on a rear of the plasma display panel 110, and the plasma display panel 110 and the chassis 141 are coupled by an adhesive member, for example, a double-sided tape. A heat dissipation member which is a thermal conductive medium can be interposed between the plasma display panel 110 and the chassis 141.

A circuit unit 160 can be disposed on a rear surface of the chassis 141. The circuit unit 160 can include a plurality of circuit boards 161 such as a logic board, a power board, and a logic buffer board, and drives the plasma display panel 110.

The circuit unit 160 transmits electrical signals to the plasma display panel 110 through a signal-transmitting member 170. The signal-transmitting member 170 can be a flexible substrate such as a tape carrier package (TCP) or a chip on film (COF). The signal-transmitting member 170 can be a package in which at least one mounted chip 172 is mounted on each tape shaped wire unit 171. A cover plate 180 can be disposed on an outer side of the mounted device 172. The cover plate 180 can be mounted on the chassis 141 by screwing a mounting bolt 183 into a female fitting hole 143 through a mounting hole 185.

In the plasma display panel 110, during plasma discharge, vibrations and noise caused by the vibrations are generated. In types of display panels, vibrations occur in displaying images. In one embodiment, the functional holes 146 are formed in the chassis 141, and the vibration preventive members 151 are inserted into the functional holes 146 of the display panel 110 where there is vibration, thereby reducing the vibration in the display panel 110.

That is, a portion of the display panel 110 where the vibrations are generated can be detected by a noise-vibration test of the display panel 110 in a coupled state with the chassis 141. The portion of the display panel 110 where the vibration is generated can be pressed by inserting the vibration preventive members 151 into the functional holes 146 from a rear side of the chassis 141, thereby preventing vibrations.

For this purpose, as depicted in FIG. 4, a plurality of the functional holes 146 are arranged across the entire surface of the chassis 141 parallel to the upper, lower, left, and right sides of the chassis 141. The vibration preventive members 151 can be selectively inserted into the functional holes 146 of the chassis 141 where the vibrations are generated. Accordingly, vibrations and noise can be simply and effectively removed. However, the present invention is not limited thereto, that is, the functional holes 146 can be concentrated in the portion of the display panel 110 where the vibration is generated.

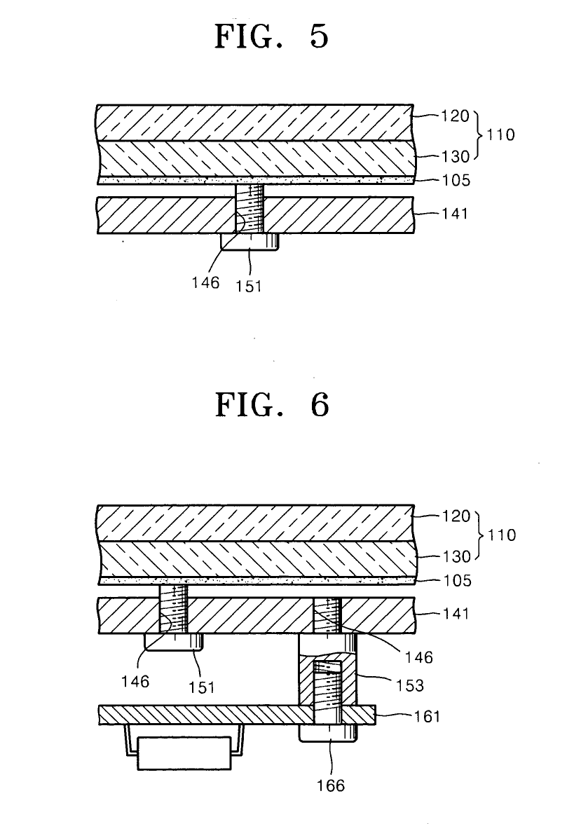

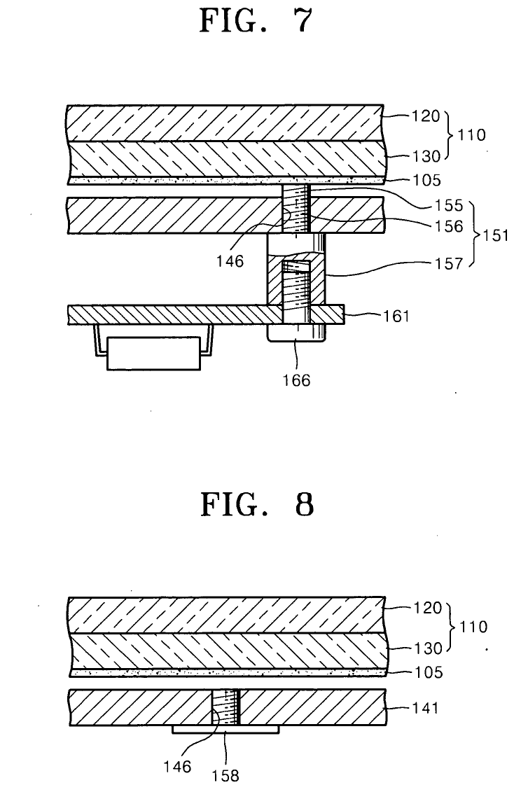

FIG. 5 is a cross-sectional view taken along a line V-V of FIG. 2, according to an embodiment of the present invention, FIG. 6 is a cross-sectional view taken along a line VI-VI of FIG. 2, according to another embodiment of the present invention, FIG. 7 is a cross-sectional view taken along a line VII-VII of FIG. 2, according to another embodiment of the present invention and FIG. 8 is a cross-sectional view taken along a line VIII-VIII of FIG. 2, according to another embodiment of the present invention. Referring to FIGS. 5 through 8, a heat dissipation member 105 having high thermal conductivity can be interposed between the display panel 110 and the chassis 141. In this case, the vibration preventive member 151 can be disposed to press the heat dissipation member 105, and accordingly, vibrations caused by the display panel 110 and the heat dissipation member 105 can be prevented. Unlike this, a through hole for passing the vibration preventive member 151 can be formed on a location of the heat dissipation member 105 corresponding to the vibration preventive member 151.

In one embodiment, as depicted in FIG. 5, a screw tap is formed in the functional hole 146, and the vibration preventive member 151 has a screw shape. Therefore, the vibration preventive member 151 may be screw coupled to the functional hole 146. That is, the vibration preventive member 151 can be easily inserted into the functional hole 146 of the chassis 141. However, the present invention is not limited thereto, that is, an inner surface of the functional hole 146 may be flat and a pin-shaped vibration preventive member can be inserted into the functional hole 146. In another embodiment, the vibration preventive member 151 is a rivet and a screw tap is not formed in the functional hole 146. In this embodiment, the size of the functional hole 146 is configured such that the rivet is tightly inserted into the flat (smooth) inner surface of the hole 146. In another embodiment, the vibration preventive member 151 can be any member which can be tightly inserted into the functional hole 146 and can sufficiently press the display panel 110 so that vibrations caused by the display panel 110 and/or the heat dissipation member 105 are minimized or removed.

Also, the vibration preventive member 151 may be formed of a plastic material or a rubber material to prevent the display panel 110 from being damaged by the vibration preventive member 151. The plastic material denotes plastic or a material having similar physical properties to the plastic, and the rubber material denotes rubber or a material having similar physical properties to the rubber. In another embodiment, the vibration preventive member 151 can be formed of any soft material as long as the pressing of the member 151 does not significantly damage the display panel 110. In still another embodiment, a plastic, rubber or other soft material (additional material) may be formed on the panel 110 or the heat dissipation member 105 which corresponds to the vibration preventive member 151. In this embodiment, the vibration preventive member 151 may not be formed of a soft material since the additional material would prevent the panel 110 from being significantly damaged.

In one embodiment, a clearance, for example, greater than about 6 mm is maintained between the circuit boards 161 that constitute the circuit unit 160 and the chassis 141 to meet the safety regulation such as the UL specification (see FIG. 6). Accordingly, usually bosses can be protruded backward from the chassis 141 to support the circuit boards 161 on the chassis 141. In one embodiment, as depicted in FIGS. 2 and 6, circuit board seating members 153 are inserted into some of the functional holes 146, and the circuit boards 161 can be seated on the circuit board seating members 153. The circuit board seating members 153 usually are boss-shaped, and can be boss-coupled or screw-coupled to the functional holes 146. That is, the circuit boards 161 can be simply seated on the circuit board seating members 153 by inserting the circuit board seating members 153 in the functional holes 146. Accordingly, to form a plurality of supporting units for seating the circuit boards 161, it is unnecessary to form the chassis 141 using a die casting method or to form additional bosses on the chassis 141, but the supporting units can be simply formed by inserting the circuit board seating members 153 into the functional holes 146. Also, a chassis assembly 140 that can meet various specifications can be formed by inserting the circuit board seating members 153 into the functional holes 146 without installing bosses applicable to various specifications on the chassis base for supporting a plurality of circuit boards. In this case, the circuit boards 161 seated on the circuit board seating members 153 can be fixed using a fixing element 166.

Also, as depicted in FIG. 7, the vibration preventive member 151 can be configured to simultaneously prevent vibration of the display panel 110 and support the circuit boards 161. For this purpose, the vibration preventive member 151 can include a panel supporting unit 155 that protrudes from the front of the chassis 141 to press the display panel 110, a coupling unit 156 which is coupled to the chassis 141, and a circuit board supporting unit 157 that protrudes from the back of the chassis 141 and is coupled to the circuit boards 161. At this time, at least outer surfaces of the panel supporting unit 155 and the coupling unit 156 may have screw threads corresponding to the tap shape of the functional holes 146.

Referring to FIGS. 2 and 8, a heat dissipation thin plate 158 can be inserted into the functional hole 146. The heat dissipation thin plate 158 is formed of a material having high thermal conductivity. Heat dissipation of the chassis 141 can be promoted when the heat dissipation thin plate 158 is selectively screw coupled to portions of the chassis 141 where heat conduction is necessary.

The functional holes 146 that are not coupled to the vibration preventive members 151, the circuit board seating members 153, and the heat dissipation thin plates 158 can be covered using additional covers.

According to at least one embodiment of the present invention, the generation of vibration and noise from a display panel can be prevented or significantly reduced by selectively pressing the display panel where the vibration is generated using vibration preventive members.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A chassis assembly, comprising:
a chassis, having first and second surfaces opposing each other, configured to support a display panel via the first surface, wherein a plurality of functional holes are defined in the chassis; and
a vibration preventive member that is inserted, from the second surface, into and passes through at least one of the functional holes, wherein the vibration preventive member is configured to press the display panel.

2. The chassis assembly of claim 1, wherein the vibration preventive member is formed of a plastic material or a rubber material.

3. The chassis assembly of claim 1, wherein a screw tap is formed in the at least one functional hole, and the vibration preventive member is a screw coupled to the functional hole.

4. The chassis assembly of claim 1, further comprising a circuit board seating member configured to support at least one circuit board electrically connected to the display panel by being inserted into at least one of the functional holes.

5. The chassis assembly of claim 1, wherein the vibration preventive member comprises: a panel supporting unit extending from the first surface of the chassis to press the display panel; a coupling unit which is coupled to the chassis; and a circuit board supporting unit that extends from the second surface of the chassis and is coupled to a circuit board electrically connected to the display panel.

6. The chassis assembly of claim 1, further comprising a heat dissipation thin plate configured to dissipate heat and to be inserted into at least one of the functional holes where the vibration preventive member is not inserted.

7. A display apparatus, comprising:
a display panel configured to display images; and
a chassis, having first and second surfaces opposing each other, configured to support the display panel via the first surface, wherein a plurality of functional holes are defined in the chassis,
wherein the chassis is configured to receive a vibration preventive member from the second surface via at least one of the functional holes, wherein the vibration preventive member is configured to pass through the at least one functional hole and press the display panel.

8. The display apparatus of claim 7, wherein the vibration preventive member is formed of a plastic material or a rubber material.

9. The display apparatus of claim 7, wherein a screw tap is formed in the at least one functional hole, and the vibration preventive member is a screw coupled to the functional hole.

10. The display apparatus of claim 7, further comprising a heat dissipation member interposed between the display panel and the chassis, wherein the vibration preventive member contacts the heat dissipation member.

11. The display apparatus of claim 7, further comprising at least one circuit board that is located on the second surface of the chassis, is supported by the chassis with a clearance, and is electrically connected to the display panel; and
a circuit board seating member configured to couple the circuit board to the chassis by being inserted into at least one of the functional holes.

12. The display apparatus of claim 7, further comprising at least one circuit board that is located on the second surface of the chassis, is supported by the chassis with a clearance, and is electrically connected to the display panel, wherein
the vibration preventive member comprises: a panel supporting unit extending from the first surface of the chassis to press the display panel; a coupling unit which is coupled to the chassis; and a circuit board supporting unit that extends from the second surface of the chassis and is coupled to the circuit board.

13. The display apparatus of claim 7, further comprising a heat dissipation thin plate configured to dissipate heat and to be inserted into at least one of the functional holes where the vibration preventive member is not inserted.

14. The display apparatus of claim 7, wherein the display panel is configured to display images using plasma discharges.

15. The display apparatus of claim 7, wherein the vibration preventive member is a rivet which is tightly inserted into the at least one functional hole which has a smooth inner surface.

16. A method of using a plasma display device, comprising:
providing a chassis, having first and second surfaces opposing each other, configured to support a display panel via the first surface, wherein a plurality of through-holes are defined in the chassis;
providing a vibration preventive member that is inserted, from the second surface, into at least one of the through-holes; and
bringing the vibration preventive member into contact with the display panel so that at least one of vibration and noise generated by the plasma display panel is substantially removed.

17. The method of claim 16, further comprising providing a heat dissipation member between the display panel and the chassis, wherein the vibration preventive member presses the display panel via the heat dissipation member.

18. The method of claim 16, wherein the vibration preventive member is formed of a material which is configured so that the display panel is not significantly damaged by the contacting.

19. The method of claim 18, wherein the material is at least one of plastic and rubber.

20. The method of claim 16, wherein a screw tap is formed in at least one of the plurality of through-holes, and the vibration preventive member is screw coupled to the through-hole.
